(19) United States
(12) Patent Application Publication
(10) Pub. No.: US 2025/0124904 A1
(43) Pub. Date: Apr. 17, 2025

(54) ELECTRONIC MUSICAL INSTRUMENT, METHOD, AND STORAGE MEDIUM THAT STORES PROGRAM

(71) Applicant: CASIO COMPUTER CO., LTD., Tokyo (JP)

(72) Inventor: Rie Maeda, Tokyo (JP)

(73) Assignee: CASIO COMPUTER CO., LTD., Tokyo (JP)

(21) Appl. No.: 18/918,384

(22) Filed: Oct. 17, 2024

(30) Foreign Application Priority Data
Oct. 17, 2023 (JP) 2023-178534

(51) Int. Cl. G10H 1/02; G06F 3/16

(52) U.S. Cl. CPC G10H 1/02; G06F 3/162

(57) ABSTRACT

There is provided an electronic musical instrument including a performance operator and at least one processor, wherein the processor performs the following: reading multiple pieces of musical tone information of musical tone information of music data sequentially, each of which is associated with a sounding timing, respectively; in a case where the read musical tone information contains first musical tone information belonging to a first musical instrument group, storing or overwriting the first musical tone information in a first area of a memory in response to the reading, every time the performance operator is operated; giving an instruction to sound a first musical tone according to the first musical tone information stored in the first area at the timing when the performance operator is operated; and in a case where the performance operator is not operated, not giving the instruction to sound the first musical tone according to the first musical tone information stored in the first area.

### CROSS-REFERENCE TO RELATED APPLICATION

This application is based upon and claims the benefit of priority from Japanese Patent Application No. 2023-178534, filed on Oct. 17, 2023, the entire specification, claims, abstract, and drawings thereof are incorporated herein by reference.

### BACKGROUND

### Technical Field

The disclosure of this specification relates to an electronic musical instrument, a method, and a storage medium that stores a program.

### Description of Related Art

There is known an electronic musical instrument having an automatic performance function to automatically progress music regardless of the presence or absence of a performance operation by a user (Japanese Unexamined Patent Application Publication No. 2007-072387).

### SUMMARY

An electronic musical instrument according to one embodiment of the present invention includes a performance operator and at least one processor, wherein the processor performs the following: reading multiple pieces of musical tone information of music data sequentially, each of which is associated with a sounding timing, respectively; in a case where the read musical tone information contains first musical tone information belonging to a first musical instrument group, storing or overwriting the first musical tone information in a first area of a memory in response to the reading; every time the performance operator is operated, giving an instruction to sound a first musical tone according to the first musical tone information stored in the first area at the timing when the performance operator is operated; and in a case where the performance operator is not operated, not giving the instruction to sound the first musical tone according to the first musical tone information stored in the first area.

### BRIEF DESCRIPTION OF DRAWINGS

FIG. 1 is a diagram illustrating the appearance of an electronic musical instrument according to one embodiment of the present invention.

FIG. 2 is a block diagram illustrating the configuration of the electronic musical instrument according to one embodiment of the present invention.

FIG. 3 is a table illustrating a timbre DB (Data Base) provided in the electronic musical instrument according to one embodiment of the present invention.

FIG. 4 is a diagram illustrating an example of a screen displayed on a display unit provided in the electronic musical instrument according to one embodiment of the present invention.

FIG. 5 is a diagram for describing an overview of the electronic musical instrument, a method, and a storage medium that stores a program according to one embodiment of the present invention.

FIG. 6 is a flowchart illustrating processing executed by a processor provided in the electronic musical instrument in one embodiment of the present invention.

FIG. 7 is a subroutine illustrating playback processing in step S105 of FIG. 6.

FIG. 8 is a subroutine illustrating pad processing in step S105 of FIG. 6.

FIG. 9 is a chart for describing an example of the playback processing illustrated in FIG. 7 and the pad processing illustrated in FIG. 8.

FIG. 10 is a chart illustrating an example of playback processing and pad processing according to modification 1.

FIG. 11 is a diagram illustrating the appearance of an electronic musical instrument according to modification 2 of the present invention.

### DETAILED DESCRIPTION

An electronic musical instrument disclosed in Japanese Unexamined Patent Application Publication No. 2007-072387 will automatically sound musical tones of a performance part if no performance operation by a user is performed until a predetermined time has elapsed from the timing when a performance operator was to be operated while automatically advancing the accompaniment. However, the user may not want to automatically sound the musical tones of the performance part.

There is room for improvement in terms of providing a performance experience suitable for the user.

One embodiment of the present invention can be suitable for assisting the performance by the user.

An electronic musical instrument according to one embodiment of the present invention, a method carried out by the electronic musical instrument as an example of a computer, and a storage medium that stores a program will be described in detail with reference to the accompanying drawings.

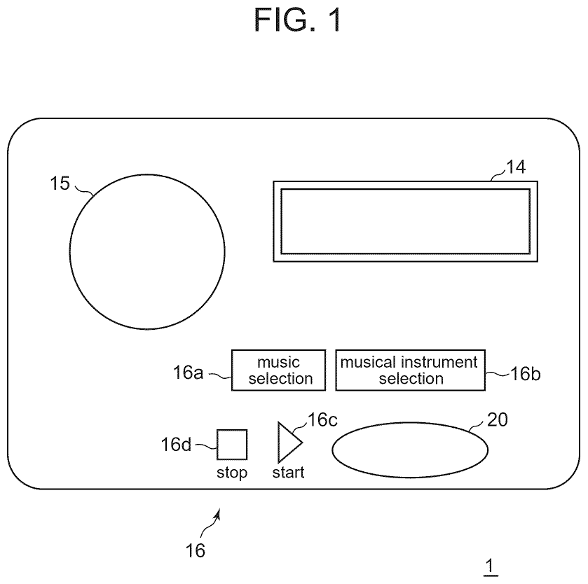

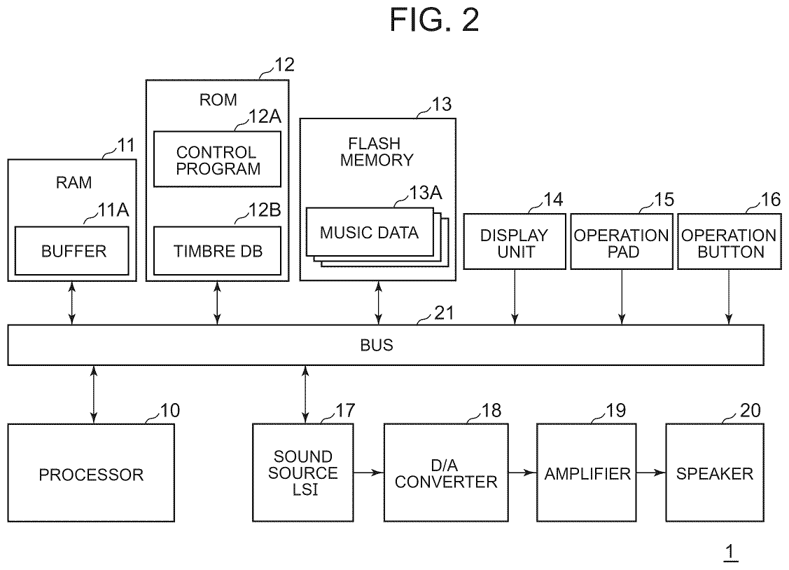

FIG. 1 is a diagram illustrating the appearance of an electronic musical instrument 1 according to one embodiment of the present invention. FIG. 2 is a block diagram illustrating the configuration of the electronic musical instrument 1. The electronic musical instrument 1 is, for example, an electronic drum kit.

The electronic musical instrument 1 may also be any other form of electronic musical instrument such as an electronic keyboard instrument, an electronic percussion instrument, an electronic wind instrument, an electronic stringed instrument, or the like.

The electronic musical instrument 1 includes, as the hardware configuration, a processor 10, a RAM (Random Access Memory) 11, a ROM (Read Only Memory) 12, a flash memory 13, a display unit 14, an operation pad 15, an operation button 16, a sound source LSI (Large Scale Integration) 17, a D/A converter 18, an amplifier 19, and a speaker 20. The respective unis of the electronic musical instrument 1 are connected by a bus 21.

The processor 10 reads a program and data stored in the ROM 12. The processor 10 uses the RAM 11 as a work area to comprehensively control the electronic musical instrument 1.

For example, the processor 10 is a single processor or a multiprocessor system, which includes at least one processor. When the processor 10 is configured to include multiple processors, the processor 10 may be packaged as a single device, or may be composed of two or more devices physically separated inside the electronic musical instrument 1. For example, the processor 10 may also be called a control unit, a CPU (Central Processing Unit), an MPU (Micro Processor Unit), or an MCU (Micro Controller Unit).

The RAM 11 temporarily holds data and programs. In the RAM 11, for example, various programs read from the ROM 12 and various data such as waveform data are held. As will be described later, a memory area (an example of a first memory area of a memory) as part of the RAM 11 is reserved as a buffer 11A.

The ROM 12 stores a control program 12A and a timbre DB 12B. The processor 10 executes the control program 12A to execute various processing according to one embodiment of the present invention.

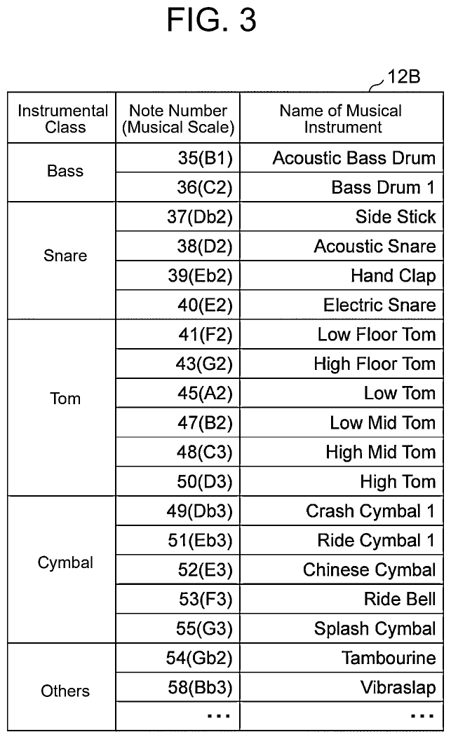

FIG. 3 is a table illustrating the timbre DB (Data Base) 12B.

An instrumental class illustrated in FIG. 3 is a musical instrument group to which at least one musical instrument belongs. In the example of FIG. 3, musical instrument parts that construct a drum kit are classified by type, and each classified type is defined as each instrumental class. Specifically, respective types of “Bass,” “Snare,” “Tom,” “Cymbal,” and “Others” are defined as instrumental classes.

In the instrumental class of “Bass,” for example, an acoustic bass drum, a bass drum, and the like are included. In the instrumental class of “Snare,” for example, an acoustic snare, an electric snare, and the like are included. In the instrumental class of “Tom,” for example, a low floor tom, a high floor tom, and the like are included. In the instrumental class of “Cymbal,” for example, a Chinese cymbal, a ride bell, and the like are included. In the instrumental class of “Others,” for example, a tambourine, an open triangle, and the like are included.

Note that the instrumental classes illustrated in FIG. 3 are just examples. For example, there is a degree of freedom as to which musical instrument is included in which instrumental class. Further, instead of or in addition to the instrumental classes illustrated in FIG. 3, there may also be instrumental classes corresponding to musical instruments other than the drum kit such as a guitar and a piano. In other words, there is a degree of freedom as to how the instrumental classes are defined, and various design changes are possible.

As illustrated in FIG. 3, the timbre DB 12B stores each musical instrument (that is, each timbre) belonging to each instrumental class and each note number in association with each other.

For example, in an acoustic drum kit (a non-electronic drum kit), when the low floor tom is hit, a sound in a musical scale of F2 is made. In order to reproduce the timbre of the low floor tom of the acoustic drum kit (the non-electronic drum kit), the low floor tom and a note number 41 indicative of the musical scale F2 are stored in the timbre DB 12B in association with each other.

The flash memory 13 stores multiple pieces of music data 13A. Note that the multiple pieces of music data 13A are pieces of music data different from one another, but the pieces of music data are indicated by the same sign 13A for convenience.

The music data 13A is created, for example, in an SMF (Standard MIDI File) format. The music data 13A contains multiple events. In each event, delta time, command type, command data, and the like are written.

In other words, the music data 13A contains multiple events (an example of musical tone information) each of which is associated with a sounding timing.

The command type is information such as note-on, note-off, control change, pitch bend change, or the like. In the MIDI (Musical Instrument Digital Interface) standard, the command type is called a status byte.

The command data is setting information on a command indicated by the command type. The command data is information on the note number, velocity, and the like. In the MIDI standard, the command data is called a data byte.

The processor 10 reads the events inside the music data 13A in order to advance the music according to the delta time described in each event.

The display unit 14 includes, for example, an LCD (Liquid Crystal Display) and an LCD controller. When the LCD controller drives the LCD according to a control signal by the processor 10, a screen according to the control signal is displayed on the LCD. The LCD may also be configured as a touch panel display. The LCD may also be replaced by an organic EL (Electro Luminescence) display, an LED (Light Emitting Diode) display, or the like.

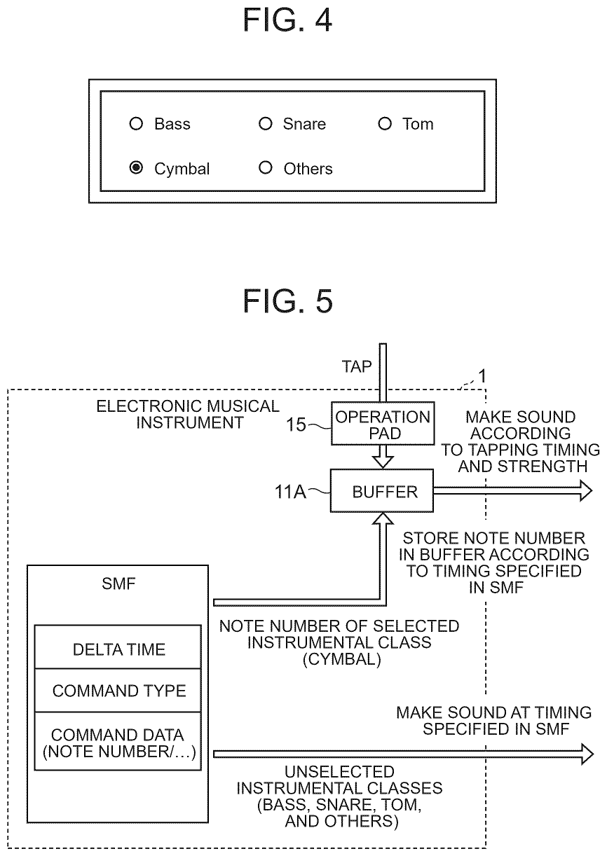

FIG. 4 illustrates a screen example to be displayed on the display unit 14. In the example of FIG. 4, an instrumental class selection screen is displayed. On the instrumental class selection screen, respective instrumental classes are displayed to be selectable.

When the user touches an instrumental class displayed on the screen, the radio button of the touched instrumental class is checked. In the example of FIG. 4, Cymbal is touched and the radio button thereof is checked.

The instrumental class selected by the user (that is, the instrumental class whose radio button is checked) is written as the “selected instrumental class” below for convenience. The instrumental classes that are not selected by the user (that is, the instrumental classes whose radio buttons are not checked) are written as “unselected instrumental classes” below.

The operation pad 15 is an example of a performance operator. When the user tapes the operation pad 15, a musical tone of the musical instrument belonging to the selected instrumental class is sounded in the electronic musical instrument 1.

In the operation pad 15, elements for measuring a user's tapping speed (velocity) on the operation pad 15 are provided. Exemplarily, regarding the operation pad 15, multiple contact switches are provided. The velocity is measured from a time difference when the respective contact switches conduct upon tapping the operation pad 15. The velocity is also said to be a value indicative of the strength of the operation, and is further said to be a value indicative of the loudness (volume) of the musical tone.

The processor 10 monitors the output of the elements mentioned above to detect the velocity when the operation pad 15 is tapped.

The operation button 16 contains multiple buttons 16a to 16d. A music selection button 16a is an operator for allowing the user to select music. A musical instrument selection button 16b is an operator for allowing the user to select an instrumental class. A play button 16c is an operator for allowing the user to give an instruction to start playing the music. A stop button 16d is an operator for allowing the user to give an instruction to stop playing the music.

Note that only some operators are illustrated in FIG. 3 for convenience. Other operators such as a power button, a volume switch, and the like are also contained in the electronic musical instrument 1.

In another embodiment, the electronic musical instrument 1 may be replaced by a smartphone, a tablet terminal, a PC (Personal Computer), a game controller, or the like. For example, the smartphone or the tablet terminal can operate as the electronic musical instrument 1 by downloading, from an App store, and installing an application to execute various processing according to one embodiment of the present invention. In this case, for example, a GUI (Graphical User Interface) on which various parts illustrated in FIG. 1 are laid out is displayed on the screen. The user can tape the operation pad 15 on the GUI to sound a musical tone of the musical instrument of the selected instrumental class, or can stop the music being played back by touching the stop button 16d on the GUI.

For example, waveform data is stored in the ROM 12. The waveform data is loaded into the RAM 11 upon the startup process of the electronic musical instrument 1 to sound a musical tone quickly according to a tapping operation. When detecting the tapping operation on the operation pad 15, the processor 10 instructs the sound source LSI 17 to read corresponding waveform data from among pieces of waveform data loaded into the RAM 11.

Under the instruction from the processor 10, the sound source LSI 17 generates a musical tone based on the waveform data read from the RAM 11. The sound source LSI 17 includes multiple generation sections so that the sound source LSI 17 can simultaneously sound musical tones corresponding, in number, to the number of generation sections at maximum. Note that, in the present embodiment, the processor 10 and the sound source LSI 17 are configured as separate processors, but in another embodiment, the processor 10 and the sound source LSI 17 may be configured as one processor.

Digital musical tone data generated by the sound source LSI 17 is converted to an analog signal by the D/A converter 18, then amplified by the amplifier 19, and output to the speaker 20.

FIG. 5 is a diagram for describing an overview of an electronic musical instrument, a method, and a storage medium that stores a program according to one embodiment of the present invention. In the example of FIG. 5, the cymbal is the selected instrumental class, and the others are unselected instrumental classes.

The electronic musical instrument 1 sequentially reads respective events contained in the SMF (that is, in the music data 13A).

When the sounding timing of a musical instrument belonging to an unselected instrumental class as the timing specified by the SMF comes, the electronic musical instrument 1 instantly gives an instruction to the sound source LSI 17 to perform a sounding process to sound a musical tone specified in the event. In other words, the electronic musical instrument 1 automatically plays the musical tone of the musical instrument belonging to the unselected instrumental class at the timing and volume specified by the SMF.

On the other hand, when the sounding timing of the musical instrument belonging to the selected instrumental class as the timing specified by the SMF comes, the electronic musical instrument 1 stores, in the buffer 11A, a note number written in the event without instantly giving the sounding instruction to the sound source LSI 17. In the buffer 11A, the latest one note number as the note number written in the event corresponding to the selected instrumental class is always overwritten and stored as the music progresses.

When the operation pad 15 is tapped by the user, the electronic musical instrument 1 instructs the sound source LSI 17 to perform the sounding process to sound the musical tone of the note number stored in the buffer 11A at that time. The volume of the musical tone to be sounded is determined according to the tapping speed (velocity) of the operation pad 15 by the user, rather than the velocity written in the event. In other words, the electronic musical instrument 1 plays the musical tone of the musical instrument belonging to the selected instrumental class at the timing and volume of the user operation.

Thus, the electronic musical instrument 1 sounds the musical tone of the musical instrument belonging to the selected instrumental class according to the operation timing and operation strength by the user while sounding musical tones of the musical instruments belonging to the unselected instrumental classes at the timings and volumes according to the music data 13A.

The user can play the musical instrument (the musical instrument belonging to the selected instrumental class) that the user wants to play at any timing and volume while automatically advancing the music and listening to musical tones of the other musical instruments (musical instruments belonging to the unselected instrumental classes). Even when the user is not good at playing the musical instrument, the user can experience to play a desired part with a subjective operation.

From another point of view, the user can play some parts (cymbals or the like) selected by the user himself or herself without playing all the parts (all the drum parts in the present embodiment). The user can enjoy the feeling of playing as if the user were performing a complicated performance only by playing some parts subjectively with simple operations.

According to the progress of the music (specifically, every time the timing of sounding a musical tone of the musical instrument belonging to the selected instrumental class comes), the note number in the buffer 11A (that is, the timbre of the musical instrument belonging to the selected instrumental class) is automatically replaced. Therefore, the user can play the music with an appropriate tone of the musical instrument to be sounded at any given time only by tapping the one operation pad 15.

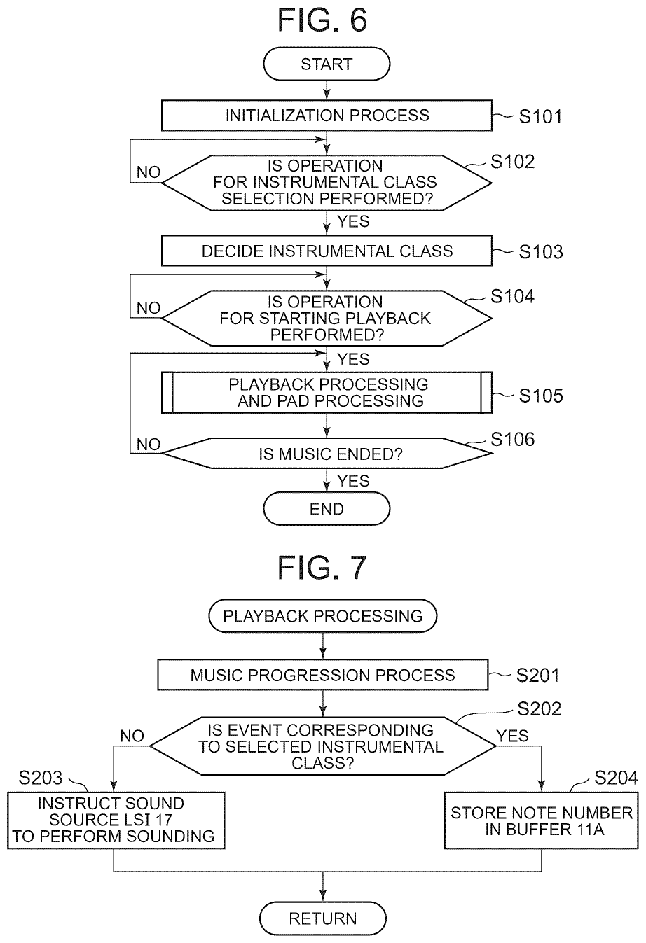

FIG. 6 is a flowchart illustrating processing executed by the processor 10 in one embodiment of the present invention. For example, when the power of the electronic musical instrument 1 is turned on, the execution of the processing illustrated in FIG. 6 is started.

As illustrated in FIG. 6, the processor 10 performs an initialization process (step S101). In the initialization process, each component is initialized. Further, variables are also initialized such as to reset the buffer 11A.

The processor 10 waits for a selection operation of an instrumental class (step S102).

Specifically, the processor 10 displays, on the display unit 14, the instrumental class selection screen (see FIG. 4) for selecting an instrumental class. This screen is a screen for letting the user select one of the multiple instrumental classes (Bass, Snare, Tom, Cymbal, Others) using the radio button.

For example, when the user touches an instrumental class displayed on the screen, the radio button of the touched instrumental class is checked. Alternatively, the instrumental class whose radio button is to be checked sequentially changes every time the user presses the musical instrument selection button 16b.

When the user presses the play button 16c (step S102: YES), the processor 10 decides the instrumental class checked when the user presses the play button 16c as the instrumental class for which the user performs a performance operation (that is, as the “selected instrumental class”) (step S103).

Note that the processor 10 also monitors operations on the other operators. For example, when the music selection button 16a is operated, the processor 10 decides music to be played back according to the operation.

After deciding the selected instrumental class, the processor 10 waits for an operation on the play button 16c (step S104). When the user presses the play button 16c (step S104: YES), the processor 10 executes playback processing and pad processing (step S105).

The processor 10 repeatedly executes the playback processing and the pad processing (step S105) until the end of the music playback is detected (step S106: YES). For example, when the music progresses to an event with an EOT (End of Track) command written in the music data 13A, the processor 10 detects the end of the music playback, and ends the processing illustrated in FIG. 6.

FIG. 7 is a subroutine illustrating the playback processing in step S105 of FIG. 6.

The processor 10 performs a music progression process (step S201).

Specifically, the processor 10 reads evens of the music data 13A in order, and advances the music according to the delta time written in each event.

The processor 10 determines whether or not the next event is an event corresponding to the selected instrumental class (step S202).

When the next event is an event corresponding to an unselected instrumental class (step S202: NO), the processor 10 instructs the sound source LSI 17 to perform the sounding process to sound the musical tone specified in the event at the timing according to the music data 13A (step S203). Note that, even when the next event is an event such as a program change or a control change, the processor 10 instructs the sound source LSI 17 to process the event at the timing according to the music data 13A.

When the next event is an event corresponding to the selected instrumental class (step S202: YES), the processor 10 stores, in the buffer 11A, the note number written in the event at the timing according to the music data 13A (step S204).

The processor 10 repeatedly executes the playback processing of FIG. 7 until the end of the music playback is detected (step S106 in FIG. 6: YES).

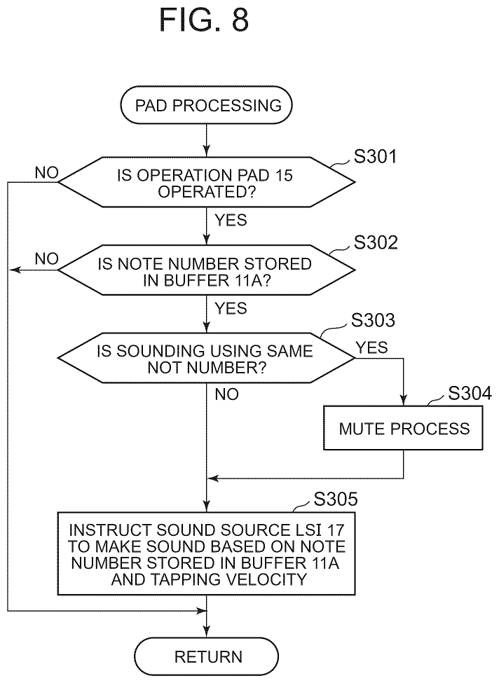

FIG. 8 is a subroutine illustrating the pad processing in step S105 of FIG. 6. The pad processing illustrated in FIG. 8 is executed in parallel with the playback processing illustrated in FIG. 7.

The processor 10 determines whether or not the operation pad 15 is operated (tapped) (step S301).

When the operation pad 15 is tapped (step S301: YES), the processor 10 determines whether or not the note number is stored in the buffer 11A (step S302).

When the note number is stored in the buffer 11A (step S302: YES), the processor 10 determines whether or not the sound source LSI 17 is sounding musical tones using the same note number (step S303).

When the sound source LSI 17 is not sounding the musical tones using the same note number (step S303: NO), the processor 10 instructs the sound source LSI 17 to sound a musical tone of the note number stored in the buffer 11A at the timing when the user tapes the operation pad 15 and the volume according to the tapping speed (velocity) (step S305).

Thus, the sound source LSI 17 sounds the musical tone of the note number stored in the buffer 11A at the timing when the user tapes the operation pad 15 and the volume according to the tapping speed (velocity).

The musical tone sounded at this time is muted according to a note-off event issued, for example, at the timing according to the tapping speed (velocity) of the operation pad 15 by the user. This musical tone may also be muted at the timing according to the tapping speed (velocity) of the operation pad 15 by the user, rather than the note-off event.

When the sound source LSI 17 is sounding the musical tone of the same note number (step S303: YES), the processor 10 instructs the sound source LSI 17 to perform a mute process (for example, note-off) of the musical tone being sounded (step S304), and instructs the sound source LSI 17 to sound a musical tone of the note number stored in the buffer 11A at the timing when the user tapes the operation pad 15 and the volume according to the tapping speed (velocity) (step S305).

Thus, the sound source LSI 17 instantly mutes the musical tone being sounded, which is the musical tone of the same note number as that stored in the buffer 11A, and sounds the musical tone of this note number at the timing when the user tapes the operation pad 15 and the volume according to the tapping speed (velocity).

When the operation pad 15 is not tapped (step S301: NO), or when the note number is not stored in the buffer 11A (step S302: NO), the processor 10 ends the pad processing in FIG. 8 without instructing the sound source LSI 17 to sound any musical tone. The processor 10 repeatedly executes the pad processing in FIG. 8 until the end of the music playback is detected (step S106 in FIG. 6: YES).

In other words, even when the music progresses to sound musical tones of musical instruments of the unselected instrumental classes during the period when the user is not tapping the operation pad 15, the musical tone of the musical instrument of the selected instrumental class is not sounded.

Thus, the processor 10 determines, for each event in the music data 13A, whether or not the event is an event corresponding to the selected instrumental class. When reaching the event processing timing to make a sound at the current progress time, the processor 10 will instantly instruct the sound source LSI 17 to perform the sounding process if the event is an event corresponding to an unselected instrumental class. On the other hand, if the event is an event corresponding to the selected instrumental class, the processor 10 will store the note number in the buffer 11A. Then, when the operation pad 15 is tapped by the user, the processor 10 instructs the sound source LSI 17 to perform the sounding process to make a sound of the note number stored in the buffer 11A at the tapping time.

In addition, the processor 10 sequentially reads events (examples of musical tone information) of the music data 13A containing multiple pieces of musical tone information with which the sounding timings are associated, respectively, and when each of the read events contains a note number of a musical instrument belonging to the selected instrumental class (an example of a first musical instrument group) (that is, the note number corresponding to the timbre of the musical instrument belonging to the selected instrumental class as an example of first musical tone information), the processor 10 overwrites and stores the note number in the buffer 11A (an example of a first area of a memory) in response to reading the event.

Every time the operation pad 15 (an example of a performance operator) is operated, the processor 10 instructs the sound source LSI 17 to sound a first musical tone of the note number according to the note number (the example of the first musical tone information) stored in the buffer 11A (the example of the first area) at the operated timing. When the operation pad 15 is not operated, the processor 10 does not instruct the sound source LSI 17 to sound the first musical tone according to the note number stored in the buffer 11A.

The processor 10 sequentially reads the events (the examples of the musical tone information) of the music data 13A containing the multiple pieces of musical tone information with which the sounding timings are associated, respectively, and when the read events contain a note number (an example of second musical tone information) of a musical instrument belonging to an unselected instrumental class (an example of a second musical instrument group different from the first musical instrument group), the processor 10 instructs the sound source LSI 17 to sound the second musical tone of this note number at the sounding timing according to the event containing this note number without storing this note number in the buffer 11A (the example of the first area of the memory).

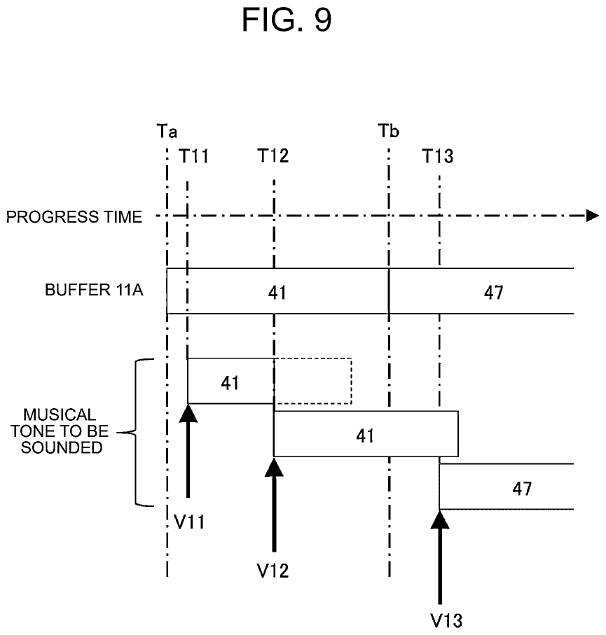

FIG. 9 is a chart for describing an example of the playback processing illustrated in FIG. 7 and the pad processing illustrated in FIG. 8. In the example of FIG. 9, it is assumed that Tom is the selected instrumental class. In FIG. 9, numbers illustrated in blocks indicate note numbers. “41” is a note number corresponding to the timbre of the low floor tom belonging to the instrumental class of Tom. “47” is a note number corresponding to the timbre of the low mid tom belonging to the instrumental class of Tom.

In FIG. 9, progress time Ta is the sounding timing of the musical tone of the low floor tom. Since the low floor tom belongs to the selected instrumental class, the processor 10 stores, in the buffer 11A, the note number (41) written in the event without instantly instructing the sound source LSI 17 to sound the musical tone of the low floor tom at the progress time Ta.

In the example of FIG. 9, the user tapes the operation pad 15 at velocity V11 at progress time T11. At the progress time T11, the processor 10 instructs the sound source LSI 17 to perform the sounding process to make a sound of the note number (41) stored in the buffer 11A.

In other words, the musical tone of the low floor tom is sounded at a user's operation timing (at the progress time T11), rather than at the timing according to the music data 13A (at the progress time Ta). This musical tone is sounded at a volume according to the strength of the user operation (velocity V11), rather than at the volume according to the music data 13A.

Thus, the user can play a musical instrument that the user wants to play (a musical instrument belonging to the selected instrumental class) at any timing and volume while automatically advancing the music and hearing to musical tones of the other musical instruments (musical instruments belonging to the unselected instrumental classes). Even when the user is not good at playing the musical instrument, the user can experience to play a desired part with a subjective operation.

In the example of FIG. 9, at progress time T12, the user taps the operation pad 15 at velocity V12. At the progress time T12, the processor 10 instructs the sound source LSI 17 to perform the mute process of the musical tone of the note number (41) being sounded, and instructs the sound source LSI 17 to perform the sounding process to make a sound of the note number (41) stored in the buffer 11A.

In other words, in the case where the operation pad 15 (the example of the performance operator) is operated while the first musical tone is being sounded, when the note number (the example of the first musical tone information) stored in the buffer 11A (the example of the first area of the memory) at the operated time is the same as the note number the musical tone of which is being sounded, the processor 10 instructs the sound source LSI 17 to mute the first musical tone being sounded and to sound a new first musical tone of the same note number.

Smooth sound similar to that when playing legato can be obtained by muting the musical tone of the same note number and sounding the new musical tone. In other words, actual drum performance can be reproduced faithfully.

On the music data 13A, the musical tone of the low floor tom is sounded only once during a period from the progress time Ta to progress time Tb. However, in the present embodiment, the user can sound musical tones of the low floor tom belonging to the selected instrumental class multiple times during the period from the progress time Ta to the progress time Tb by repeatedly tapping the operation pad 15.

Thus, the user can play a performance part (the musical instrument belonging to the selected instrumental class) by freely deciding not only the sounding timings and volumes but also the number of sounding times.

In FIG. 9, the progress time Tb is a sounding timing of a musical tone of the low mid tom. Since the low mid tom belongs to the selected instrumental class, the processor 10 overwrites and stores, in the buffer 11A, note number (47) written in the event without instantly instructing the sound source LSI 17 to sound the musical tone of the low mid tom at the progress time Tb. The note number (41) stored in the buffer 11A is erased by overwriting.

In the example of FIG. 9, at progress time T13, the user taps the operation pad 15 at velocity V13. At the progress time T13, the processor 10 instructs the sound source LSI 17 to perform the sounding process to sound the note number (47) stored in the buffer 11A.

In other words, the musical tone of the low mid tom is sounded at the user's operation timing (at the progress time T13), rather than at the timing according to the music data 13A (at the progress time Tb). This musical tone is sounded at a volume according to the strength of the user's operation (velocity V13), rather than at the volume according to the music data 13A.

Note that the note number (41) of the musical tone being sounded at the progress time T13 is different from the note number (47) stored in the buffer 11A at the progress time T13. Therefore, at the progress time T13, the processor 10 does not the sound source LSI 17 to perform the mute process of the musical tone of the note number (41) being sounded. As a result, sounding of the musical tone of the note number (47) is started in such a state that the musical tone of the note number (41) continues to be sounded. Thus, such actual drum performance that two or more musical tones (here, the musical tones of the low floor tom and the low mid tom) are sounded simultaneously can be reproduced faithfully.

According to the progress of the music, the note number in the buffer 11A (that is, the timbre of the musical instrument belonging to the selected instrumental class) is automatically replaced. Therefore, the user can play the music with an appropriate tone of the musical instrument to be sounded at any given time only by tapping the one operation pad 15.

Otherwise, the present invention is not limited to the embodiment described above, and can be modified in various ways without departing from the scope thereof at the implementation stage. Further, the functions implemented in the embodiment described above may be combined appropriately as much as possible and implemented. Various stages are contained in the embodiment described above, and various inventions can be extracted by appropriately combining two or more disclosed constituent features. For example, even when some constituent features are deleted from all the constituent features described in the embodiment, a configuration from which the constituent features are deleted can be extracted as an invention as long as the effect can be obtained.

In the aforementioned embodiment, such a case that each musical tone is a single note is described. However, in actual drum performance, two or more musical tones are often sounded at the same time such as a case where high-hat and clash cymbals are sounded at the same time. Therefore, the musical tone may also be a chord.

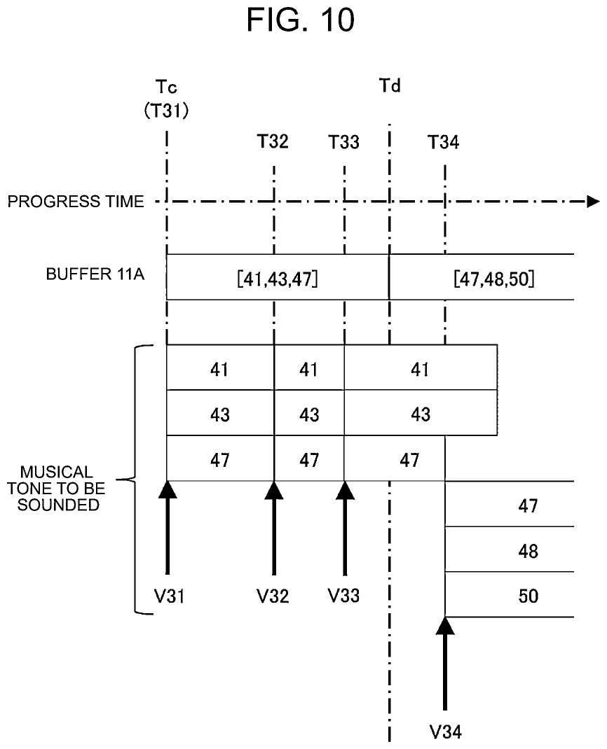

FIG. 10 is a chart illustrating an example of playback processing and pad processing according to modification 1. Even in the example of FIG. 10, it is assumed that Tom is the selected instrumental class. In FIG. 10, numbers “41,” “43,” “47,” “48,” and “50” in blocks are note numbers corresponding to timbres of the low floor tom, the high floor tom, the low mid tom, the high mid tom, and the high tom belonging to the instrumental class of Tom, respectively.

The buffer 11A has an array capable of memorizing note numbers (that is, multiple note numbers) corresponding to a chord. In FIG. 10, “41, 43, 47” indicate an array of note numbers corresponding to three timbres (low floor tom, high floor tom, low mid tom). “47, 48, 50” indicate an array of note numbers corresponding to the other three timbres (low mid tom, high mid tom, high tom).

In the modification 1, multiple musical tones that fit into a predetermined duration (for example, a duration corresponding to a hundred twenty-eighth note that can be considered to be sounded simultaneously) are considered to be sounded simultaneously. When there are multiple musical tones considered to be sounded simultaneously, the processor 10 stores, in the buffer 11A, an array of note numbers corresponding to these musical tones.

In FIG. 10, progress time Tc is a sounding timing of multiple musical tones (whose note numbers are 41, 43, and 47, respectively) considered to be sounded simultaneously. Since musical instruments corresponding to these musical tones belong to the selected instrumental class, the processor 10 stores the note numbers (41, 43, and 47) in the buffer 11A without instantly instructing the sound source LSI 17 to sound the multiple musical tones at the progress time Tc.

In the example of FIG. 10, the user taps the operation pad 15 at velocity V31 at progress time T31 almost at the same time as the progress time Tc. At the progress time T31, the processor 10 instructs the sound source LSI 17 to perform the sounding process to sound musical tones (that is, three musical tones) of the note numbers (41, 43, and 47) stored in the buffer 11A.

In the example of FIG. 10, at progress times T32 and T33, the user taps the operation pad 15 at velocities V32 and V33, respectively. At each of the progress times T32 and T33, the processor 10 instructs the sound source LSI 17 to perform the mute process of the musical tones of the note numbers (41, 43, and 47) being sounded to mute these musical tones, and instructs the sound source LSI 17 to perform the sounding process to sound the musical tones of the note numbers (41, 43, and 47) stored in the buffer 11A.

In FIG. 10, progress time Td is a sounding timing of multiple musical tones (whose note numbers are 47, 48, and 50, respectively) considered to be sounded simultaneously. Since the musical instruments corresponding to these musical tones belong to the selected instrumental class, the processor 10 overwrites and stores the corresponding note numbers (47, 48, and 50) in the buffer 11A without instantly instructing the sound source LSI 17 to sound the multiple musical tones at the progress time Td.

In the example of FIG. 10, at progress time T34, the user taps the operation pad 15 at velocity V34. At the progress time T34, the musical tones of the note numbers (41, 43, and 47) are being sounded, and the note numbers (47, 48, and 50) are stored in the buffer 11A. In other words, the note number (47) among the note numbers (41, 43, and 47) is stored in the buffer 11A at the progress time T34.

To reproduce drum performance faithfully, the processor 10 mutes only the musical tone of the same note number like in the aforementioned embodiment. Specifically, at the progress time T34, the processor 10 mutes only the musical tone of the same note number as the note number stored in the buffer 11A among the three musical tones (whose note numbers are 41, 43, and 47, respectively) being sounded (that is, only the musical tone of the note number (47)), and instructs the sound source LSI 17 to sound new three musical tones (whose note numbers are 47, 48, and 50, respectively) including the musical tone corresponding to that of the deleted note number (47).

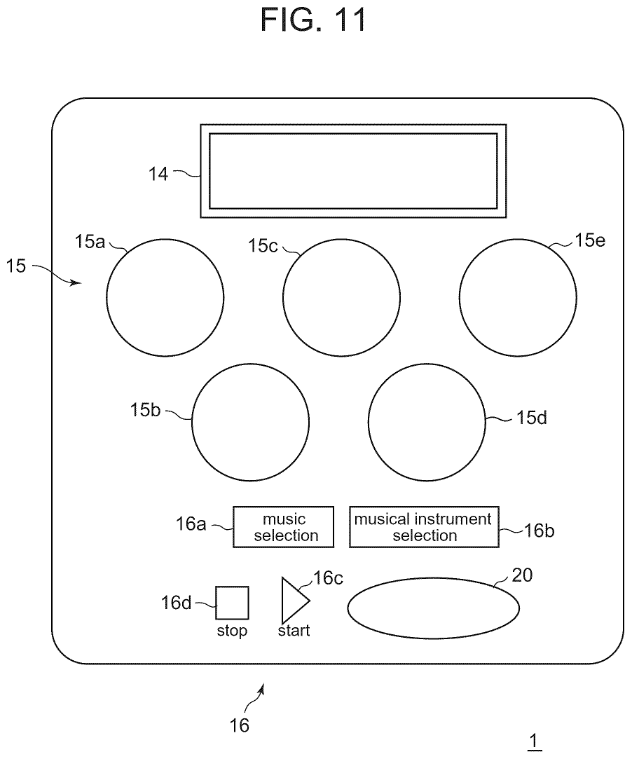

FIG. 11 is a diagram illustrating the appearance of an electronic musical instrument 1 according to modification 2. In the modification 2, the electronic musical instrument 1 includes multiple operation pads 15a to 15e. The operation pads 15a to 15e are associated with other instrumental classes (an example of musical instrument groups) of Bass, Snare, Tom, Cymbal, and Others, respectively. For example, when the user taps the operation pad 15a, a musical tone of a musical instrument belonging to the instrumental class of Bass is sounded in the electronic musical instrument 1.

In the modification 2, one or two or more instrumental classes can be set as selected instrumental classes.

As an example, the processor 10 decides two instrumental classes of Bass and Snare as selected instrumental classes according to user operations. In this case, the processor 10 causes the sound source LSI 17 to perform the sounding process of musical tones of musical instruments belonging to the selected instrumental classes (Bass and Snare) according to the timings and strengths of the user operations on the operation pad 15a and 15b while instructing the sound source LSI 17 to perform the sounding process of musical tones of musical instruments belonging to unselected instrumental classes (Tom, Cymbal, and Others) at the timings and volumes according to the music data 13A.

In the modification 2, the processor 10 sets only an operation pad (the example of the performance operator) corresponding to the instrumental class (the example of the first musical instrument group) selected with a user operation to be able to accept the user operation. In other words, the processor 10 sets user operations on operation pads corresponding to unselected instrumental classes not to be able to be accepted.

In the modification 2, since the operation pads corresponding to the selected instrumental classes are made operable, and the operation pads corresponding to the unselected instrumental classes are made inoperable, the user can enjoy the feeling of performing an even more complicated performance while guaranteeing the performance to be performed easily.

What is claimed is:

1. An electronic musical instrument comprising:
a performance operator; and
at least one processor, wherein
the at least one processor performs the following:
reading plural pieces of musical tone information of music data sequentially, each of which is associated with a sounding timing, respectively;
in a case where the read musical tone information contains first musical tone information belonging to a first musical instrument group, storing or overwriting the first musical tone information in a first area of a memory in response to the reading;
every time the performance operator is operated, giving an instruction to sound a first musical tone according to the first musical tone information stored in the first area at a timing when the performance operator is operated; and
in a case where the performance operator is not operated, not giving the instruction to sound the first musical tone according to the first musical tone information stored in the first area.

2. The electronic musical instrument according to claim 1, wherein in a case where the read musical tone information contains second musical tone information belonging to a second musical instrument group different from the first musical instrument group, the at least one processor performs
giving an instruction to sound a second musical tone according to the second musical tone information at a sounding timing without storing the second musical tone information in the first area.

3. The electronic musical instrument according to claim 1, wherein the first musical tone information is a note number corresponding to a timbre of each musical instrument, and a plurality of note numbers belong to the first musical instrument group.

4. The electronic musical instrument according to claim 1, wherein in a case where the performance operator is operated while sounding the first musical tone, when the first musical tone information stored in the first area at the operated time is the same as the first musical tone information according to the first musical tone being sounded, the at least one processor performs:
muting the first musical tone being sounded; and
giving an instruction to sound new one of the first musical tone according to the same first musical tone information.

5. The electronic musical instrument according to claim 1, wherein
the first musical tone is a chord containing a plurality of musical tones, and
in a case where the performance operator is operated while sounding the chord, the at least one processor performs:
deleting a musical tone of the same first musical tone information as that stored in the first area at the operated time among musical tones contained in the chord being sounded; and
giving an instruction to sound a new chord containing the deleted musical tone.

6. The electronic musical instrument according to claim 1, further comprising a plurality of the performance operators, wherein the plurality of performance operators correspond to different musical instrument groups, respectively, and the at least one processor performs setting only a performance operator corresponding to the first musical instrument group selected with a user operation to be able to accept the user operation.

7. A method of causing at least one processor to execute the following processing of:
reading plural pieces of musical tone information of music data sequentially, each of which is associated with a sounding timing, respectively;
in a case where the read musical tone information contains first musical tone information belonging to a first musical instrument group, storing or overwriting the first musical tone information in a first area of a memory in response to the reading;
every time a performance operator is operated, giving an instruction to sound a first musical tone according to the first musical tone information stored in the first area at a timing when the performance operator is operated; and
in a case where the performance operator is not operated, not giving the instruction to sound the first musical tone according to the first musical tone information stored in the first area.

8. The method according to claim 7, wherein in a case where the read musical tone information contains second musical tone information belonging to a second musical instrument group different from the first musical instrument group, the at least one processor performs
giving an instruction to sound a second musical tone according to the second musical tone information at a sounding timing without storing the second musical tone information in the first area.

9. The method according to claim 7, wherein the first musical tone information is a note number corresponding to a timbre of each musical instrument, and a plurality of note numbers belong to the first musical instrument group.

10. The method according to claim 7, wherein in a case where the performance operator is operated while sounding the first musical tone, when the first musical tone information stored in the first area at the operated time is the same as the first musical tone information according to the first musical tone being sounded, the at least one processor performs:
muting the first musical tone being sounded; and
giving an instruction to sound new one of the first musical tone according to the same first musical tone information.

11. The method according to claim 7, wherein
the first musical tone is a chord containing a plurality of musical tones, and
in a case where the performance operator is operated while sounding the chord, the at least one processor performs:
deleting a musical tone of the same first musical tone information as that stored in the first area at the operated time among musical tones contained in the chord being sounded; and
giving an instruction to sound a new chord containing the deleted musical tone.

12. The method according to claim 7, wherein a plurality of the performance operators corresponding to different musical instrument groups, respectively, are further included, and the at least one processor performs setting only a performance operator corresponding to the first musical instrument group selected with a user operation to be able to accept the user operation.

13. A storage medium that stores a program for causing at least one processor to execute the following processing of:
reading plural pieces of musical tone information of music data sequentially, each of which is associated with a sounding timing, respectively;
in a case where the read musical tone information contains first musical tone information belonging to a first musical instrument group, storing or overwriting the first musical tone information in a first area of a memory in response to the reading;
every time a performance operator is operated, giving an instruction to sound a first musical tone according to the first musical tone information stored in the first area at a timing when the performance operator is operated; and
in a case where the performance operator is not operated, not giving the instruction to sound the first musical tone according to the first musical tone information stored in the first area.

14. The storage medium that stores the program according to claim 13, wherein in a case where the read musical tone information contains second musical tone information belonging to a second musical instrument group different from the first musical instrument group, the at least one processor performs
giving an instruction to sound a second musical tone according to the second musical tone information at a sounding timing without storing the second musical tone information in the first area.

15. The storage medium that stores the program according to claim 13, wherein the first musical tone information is a note number corresponding to a timbre of each musical instrument, and a plurality of note numbers belong to the first musical instrument group.

16. The storage medium that stores the program according to claim 13, wherein in a case where the performance operator is operated while sounding the first musical tone, when the first musical tone information stored in the first area at the operated time is the same as the first musical tone information according to the first musical tone being sounded, the at least one processor performs:
muting the first musical tone being sounded; and
giving an instruction is given to sound new one of the first musical tone according to the same first musical tone information.

17. The storage medium that stores the program according to claim 13, wherein
the first musical tone is a chord containing a plurality of musical tones, and
in a case where the performance operator is operated while sounding the chord, the at least one processor performs:
deleting a musical tone of the same first musical tone information as that stored in the first area at the operated time among musical tones contained in the chord being sounded, and
giving an instruction to sound a new chord containing the deleted musical tone.

18. The storage medium that stores the program according to claim 13, wherein a plurality of the performance operators are further included, where the plurality of performance operators correspond to different musical instrument groups, respectively, and the at least one processor performs setting only a performance operator corresponding to the first musical instrument group selected with a user operation is set to be able to accept the user operation.
